(19) United States
(12) Patent Application Publication
(10) Pub. No.: US 2007/0001965 A1
(43) Pub. Date: Jan. 4, 2007

(54) Driving integrated circuit of liquid crystal display device and driving method thereof

(75) Inventor: Ju-Young Lee, Gyeongsangbuk-do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/372,069

(22) Filed: Mar. 10, 2006

(30) Foreign Application Priority Data
Jun. 30, 2005 (KR) 58936/2005
Mar. 9, 2006 (KR) 22360/2006

(51) Int. Cl. G09G 3/36

(52) U.S. Cl. 345/96

(57) ABSTRACT

A driving circuit for driving a liquid crystal display device includes at least one first driving integrated circuit receiving a first polarity control signal, and at least one second driving integrated circuit receiving a second polarity control signal, the first polarity control signal being different from the second polarity control signal, the first and second driving integrated circuits respectively modifying a polarity of a set of video signals in accordance with the first and second polarity control signals.

The present invention claims the benefit of Korean Patent Applications No. 58936/2005 filed in Korea on Jun. 30, 2005 and 22360/2006 filed in Korea on Mar. 9, 2006, which is hereby incorporated by reference.

### BACKGROUND OF THE INVENTION

1. Field of the Invention

The present invention relates to a display device, and more particularly, a driving integrated circuit of a liquid crystal display device and a driving method thereof that prevent a crosstalk caused by a signal interference between pixel signals when a character image is partially displayed on the liquid crystal display device.

2. Discussion of the Related Art

A liquid crystal display (LCD) device displays images by controlling light transmittance of liquid crystal cells according to an inputted video signal. An LCD device includes an LCD panel and a driving integrated circuit (IC) for driving the LCD panel.

In general, an LCD panel includes liquid crystal cells arranged in a matrix that are defined by intersections between gate lines and data lines. Each of the liquid crystal cells includes a pixel electrode and a common electrode for generating an electric field. In particular, each pixel electrode is connected to one of the data lines via a switching device, such as a thin film transistor. A gate of the thin film transistor is connected to one of the gate lines. The data and gate lines are driven to apply a video signal to the liquid crystal cells row-by-row, i.e., one line at a time.

A driving integrated circuit includes a gate driving integrated circuit for driving the gate lines, a data driving integrated circuit for driving the data lines and a common voltage generator for driving the common electrodes. The gate driving integrated circuit sequentially supplies a scanning signal, namely, a gate signal, to the gate lines to sequentially drive the liquid crystal cells in the LCD panel line by line. The data driving integrated circuit supplies a video signal to each data line whenever the gate signal is applied to one of the gate lines. In addition, the common voltage generator applies a common voltage signal to each common electrode.

Accordingly, alignment of the liquid crystal molecules between the pixel electrode and the common electrode is changed by the applied video signal, and thus a light-transmittance of the liquid crystal cells is controlled, thereby displaying images on the LCD panel.

FIG. 1 is a schematic diagram illustrating a liquid crystal display device according to the related art. In FIG. 1, an LCD device includes a liquid crystal panel 31, a gate driver IC 13 and a data driver IC 23. The liquid crystal panel 31 includes a plurality of gate lines GL1 . . . GLn, a plurality of data lines DL1 . . . DLm, and a plurality of liquid crystal cells defined by the intersections of the gate lines GL1 . . . GLn and the data lines DL1 . . . DLm. The gate driver IC 13 provides a gate signal to the gate lines GL1 . . . GLn in the LCD panel 31, and the data driver IC 23 provides a video signal to the data lines DL1 . . . DLm in the LCD panel 31.

In the LCD panel 31, the liquid crystal cells are arranged in a matrix form and include a thin film transistor at each intersection between the n gate lines GL1 . . . GLn and the m data lines DL1 . . . DLm. The thin film transistors supply a video signal from each data line DL1 . . . DLm to each liquid crystal cell in response to a gate signal from each gate line GL1 . . . GLn. Each liquid crystal cell can be equivalently implemented as a liquid crystal capacitor CLc including a common electrode and a pixel electrode connected to each thin film transistor, the common electrode and the pixel electrode facing each other with a liquid crystal layer interposed therebetween.

A storage capacitor (not shown) is further formed in the liquid crystal cell to maintain a voltage of the video signal charged (applied) to the liquid crystal capacitor CLc until the next video signal is supplied. The storage capacitor is formed between a gate electrode of a preceding cell and the pixel electrode. The gate driver IC 13 sequentially supplies the gate signal to the gate lines GL1 . . . GLn to respectively drive the thin film transistors connected to the corresponding gate lines GL . . . GLn.

The data driver IC 23 converts video data into a analog video signal and supplies the analog video signals corresponding to one horizontal line to the respective data lines DL1 . . . DLm for one horizontal period of supplying of the gate signal to the gate lines GL1 . . . GLn. The data driver IC 23 converts the video data into the video signal using a gamma voltage applied from a gamma generator (not shown).

In general, an LCD device may use an inversion driving scheme, such as a frame inversion scheme, a line (column) inversion scheme or a dot inversion scheme to drive the liquid crystal cells in a LCD panel. The frame inversion scheme inverts a polarity of the video signal applied to each liquid crystal cell in an LCD panel when the frame is changed.

In addition, the line inversion scheme inverts the polarity of each video signal applied to the LCD panel for every gate line on the LCD panel and for every frame. When using the line inversion driving scheme, a flicker, such as a striped pattern, may occur between horizontal lines due to crosstalk between adjacent horizontal pixels.

Further, the dot inversion scheme supplies the immediately adjacent liquid crystal cells in the horizontal and vertical directions with different polarities of video signal. The dot inversion scheme also inverts the polarity of the video signal for every frame. Thus, under the dot inversion scheme, when displaying the video signal of an odd-numbered frame, the video signals are supplied to the liquid crystal cells, such that positive polarity (+) and negative polarity (−) signals are alternately supplied as each video signal is applied from the liquid crystal cell at an upper left side portion to the liquid crystal cell at a right side and to the liquid crystal cells at a lower side. Conversely, when displaying the video signal of an even-numbered frame, the video signals are alternately supplied to the liquid crystal cells, respectively, such that the negative polarity (−) and the positive polarity (+) signals are alternately supplied as each video signal is applied from the liquid crystal cell at the upper left side portion to the liquid crystal cell at the right side and to the liquid crystal cells at the lower side.

In the dot inversion driving scheme, the flicker generated between pixels adjacent to each other in the vertical and horizontal directions is attenuated. Accordingly, high quality images are provided.

However, under the dot inversion driving scheme, the polarity of the video signal supplied to the data lines from the data driving integrated circuit must be inverted in the horizontal and vertical directions. Thus, a variation amount in a pixel voltage, namely, a frequency of the applied video signal is high under the dot inversion scheme, thereby disadvantageously increasing power consumption.

FIG. 2 is a schematic diagram illustrating an one-dot inversion driving scheme for a liquid crystal display device according to the related art, and FIG. 3 is a schematic diagram illustrating each pixel voltage polarity upon using the method shown in FIG. 2. As illustrated in FIG. 2, a polarity control line 115 applies a polarity control signal POL to each data driver ICs 120 and 125. In a liquid crystal display panel 130 driven using the one-dot inversion driving scheme, each liquid crystal cell, shown as a dot, has a polarity that is different from its immediately adjacent liquid crystal cells both in the horizontal and vertical directions. Thus, immediately adjacent liquid crystal cells attenuate each other's charges. For example, when a white screen or black screen is driven, a charged amount of a charge having a positive polarity (+) and a charged amount of a charge having a negative polarity (−) are attenuated by each other to a common voltage Vcom, which is not problematic.

However, if a particular pattern is driven, the charged amount of the charge having the positive polarity (+) and the charged amount of the charge having the negative polarity (−) are attenuated by each other to a voltage greater or smaller than the Vcom, which causes a problem. As a result, voltage levels being different from the original voltage levels are applied to the positive polarity or the negative polarity at the time of driving the display of a pixel data, resulting in an occurrence of crosstalk due to such voltage level variation. In particular, as the size of a display panel increases, crosstalk becomes more severe.

As shown in FIG. 3, a plurality of vertical one-pixel-wide lines 140 are displayed in proximity to one another on the screen by setting one pixel column to a black-level, shown as shaded, and by setting two immediately adjacent pixel columns to a white-level. Each pixel column may include red, green, and blue sub-color columns, and each of the data driver ICs 120 and 125 drives a plurality of pixel columns.

Considering a polarity of one horizontal line on the basis of one data driving integrated circuit, since the charged amount of the charge with the positive polarity (+) is greater than that of the charge with the negative polarity (−) or vice versa, both the charge with the positive polarity and the charge with the negative polarity are attenuated by each other to a voltage that the sum of both charged amounts is greater or smaller than the Vcom. For example, when a gamma voltage ranges from 1V to 15V and a common voltage is 8V, pixels on the first horizontal line driven by the left data driver IC 120 have the following actual voltages: 1V, 15V, 1V, 9V, 7V, 9V, 1V, 15V, 1V, 9V, 7V, and 9V. As such, the actual average voltage is 7V, which differs from the common voltage of 8V.

In addition, pixels on the first horizontal line driven by the right data driver IC 125 have similar actual voltages, yielding the same actual average voltage to 7V. Because the common voltage is greater than the actual average voltage, the data driving integrated circuit requires more current. Thus, a uniform current applied to data driver ICs is changed, thereby causing a voltage variation operating a LCD panel.

As a result, a gamma voltage inputted to the entire data driving integrated circuits or a common voltage is affected due to such a voltage variation, resulting character crosstalk and generating an undesired one-line wide character around the one-line wide character to be desirably outputted. It may be more problematic when the one-line wide character is consecutively generated over two or more data driving integrated circuits.

FIG. 4 is a schematic diagram illustrating a horizontal two-dot inversion scheme for driving a liquid crystal display device according to the related art, and FIG. 5 is a schematic diagram illustrating each pixel voltage polarity upon using the method shown in FIG. 4. In FIG. 4, a polarity control line 215 applies a polarity control signal POL to each data driver ICs 220 and 225. In a liquid crystal display panel 230 driven using the horizontal two-dot inversion scheme, when a liquid crystal cell, shown as a dot, has four immediately adjacent liquid crystal cells, such a cell has a polarity that is the same as one of its horizontal immediately adjacent cells but is different from the other three immediately adjacent cells. In other words, the horizontal two-dot inversion scheme alternately applies two positive and two negative polarity control signals, e.g., ‘++−−++−−++−−,’ in a horizontal direction, and a vertical two-dot inversion scheme alternately applies two positive and two negative polarity control signals, e.g., ‘++−−++−−,’ in a vertical direction. However, similar to the one-dot inversion scheme, the horizontal two-dot inversion scheme generates character crosstalk.

As shown in FIG. 5, a plurality of vertical two-pixel-wide lines 330 are displayed in proximity to one another on the screen by setting two adjacent pixel columns to a black-level, shown as shaded, and by setting two immediately adjacent pixel columns to a white-level. Each pixel column may include red, green, and blue sub-color columns, and each of the data driver ICs 220 and 225 drives a plurality of pixel columns.

Since the charged amount of the charge with the positive polarity (+) is greater than that of the charge with the negative polarity (−) or vice versa, both the charge with the positive polarity and the charge with the negative polarity are attenuated by each other to a voltage that is greater or smaller than the Vcom. For example, when a gamma voltage ranges from 1V to 15V and a common voltage is 8V, pixels on the first horizontal line driven by the left data driver IC 220 have the following actual voltages: 1V, 15V, 15V, 7V, 7V, 9V, 9V, 7V, 7V, 15V, 15V, and 1V. As such, the actual average voltage is 9V, which differs from the common voltage of 8V.

In addition, pixels on the first horizontal line driven by the right data driver IC 225 have similar actual voltages, yielding the same actual average voltage to 9V. Because the common voltage is lower than the actual average voltage, the data driving integrated circuits 220 and 225 require more current. Thus, a uniform current applied to all data driver ICs is changed, thereby causing a voltage variation operating a LCD panel. In particular, the data driver ICs 220 and 225 require more current, while a common voltage is applied to other data driver ICs.

As a result, a gamma voltage inputted to the entire data driving integrated circuits or a common voltage is affected, resulting character crosstalk and generating an undesired two-line character around the two-line wide character to be desirably outputted.

### SUMMARY OF THE INVENTION

Accordingly, the present invention is directed to a driving integrated circuit of a liquid crystal display device and a driving method thereof that substantially obviate one or more problems due to limitations and disadvantages of the related art.

An object of the present invention is to provide a driving integrated circuit of an LCD panel and a driving method thereof which are capable of preventing crosstalk from occurring due to a signal interference between pixels according to a driving signal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a driving circuit for driving a liquid crystal display device includes at least one first driving integrated circuit receiving a first polarity control signal, and at least one second driving integrated circuit receiving a second polarity control signal, the first polarity control signal being different from the second polarity control signal, the first and second driving integrated circuits respectively modifying a polarity of a set of video signals in accordance with the first and second polarity control signals.

In another aspect of the present invention, a method of driving a liquid crystal display device includes generating a first polarity control signal, generating a second polarity control signal, the first polarity control signal being different from the second polarity control signal, applying the first polarity control signal to at least one first driving integrated circuit, applying the second polarity control signal to at least one second driving integrated circuit, controlling a polarity of a first set of video signals in accordance with the first polarity control signal, and controlling a polarity of a second set of video signals in accordance with the second polarity control signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic diagram illustrating a liquid crystal display device according to the related art;

FIG. 2 is a schematic diagram illustrating an one-dot inversion driving scheme for a liquid crystal display device according to the related art;

FIG. 3 is a schematic diagram illustrating each pixel voltage polarity upon using the method shown in FIG. 2;

FIG. 4 is a schematic diagram illustrating a horizontal two-dot inversion scheme for driving a liquid crystal display device according to the related art;

FIG. 5 is a schematic diagram illustrating each pixel voltage polarity upon using the method shown in FIG. 4;

FIG. 6 is a schematic diagram illustrating a driving scheme by applying an one-dot inversion driving scheme in accordance with an embodiment of the present invention;

FIG. 7 is a schematic diagram illustrating each pixel voltage polarity upon using the method shown in FIG. 6 in accordance with an embodiment of the present invention;

FIG. 8 is a schematic diagram illustrating a driving scheme by applying a horizontal two-dot inversion driving scheme in accordance with another embodiment of the present invention; and

FIG. 9 is a schematic diagram illustrating each pixel voltage polarity upon using the method shown in FIG. 8 in accordance with an embodiment of the present invention.

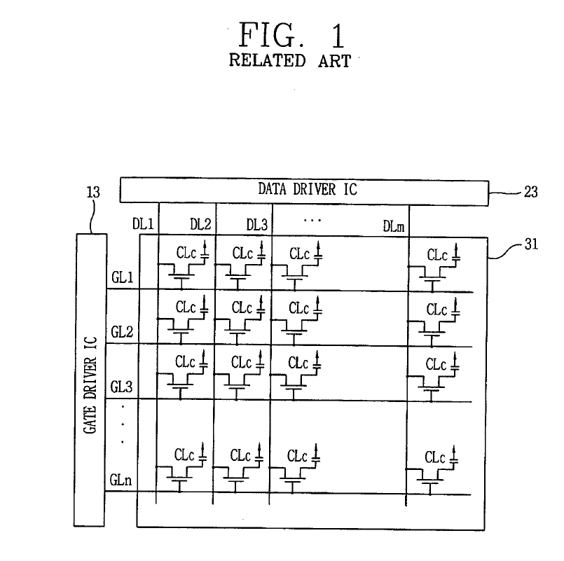

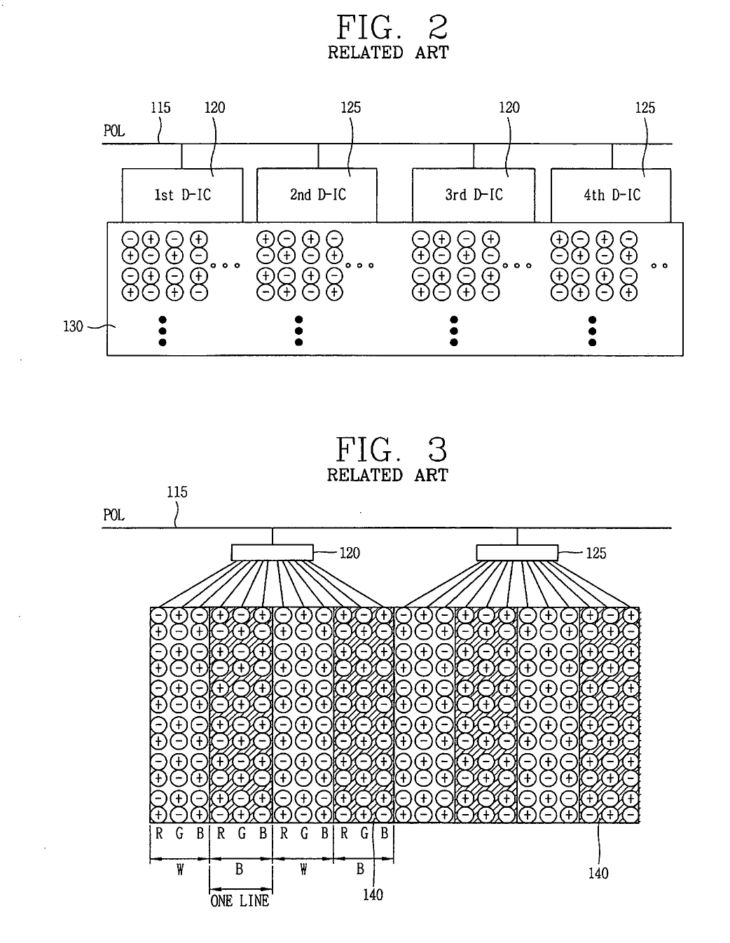

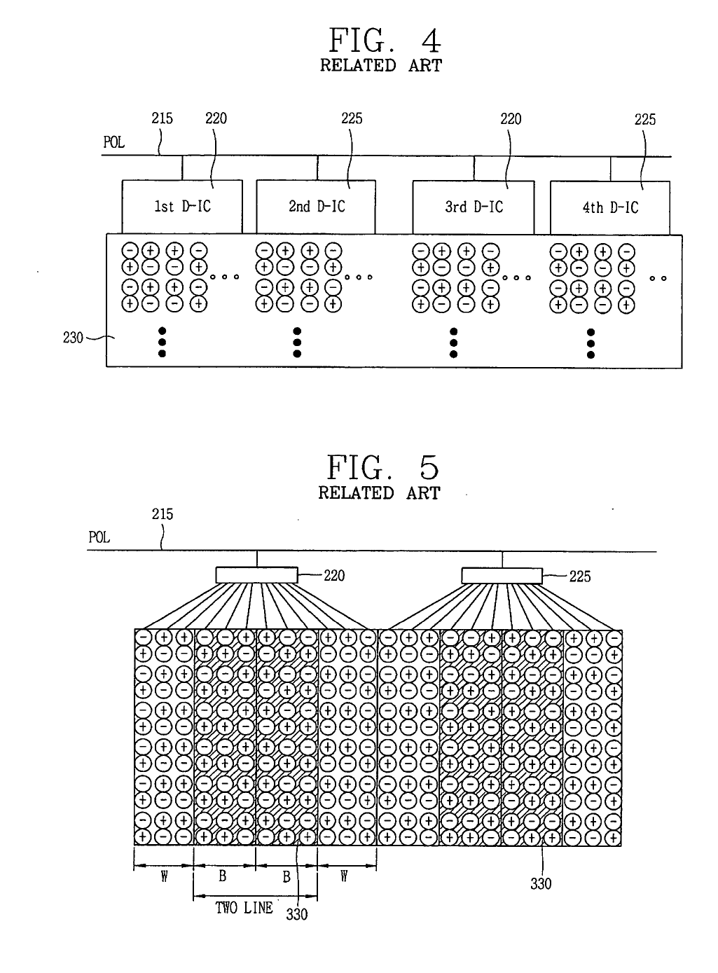

### DETAILED DESCRIPTION OF THE PREFERRED EMBODIMENTS

Reference will now be made in detail to preferred embodiments of the present invention, examples of which are illustrated in the accompanying drawings.

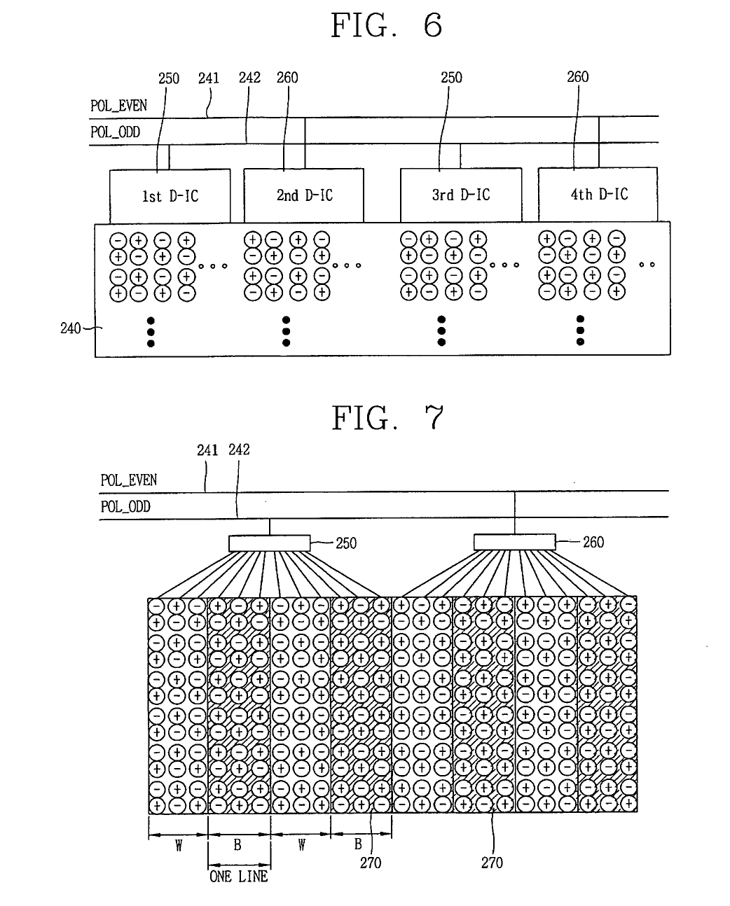

FIG. 6 is a schematic diagram illustrating a driving scheme by applying an one-dot inversion driving scheme in accordance with an embodiment of the present invention. In FIG. 6, a driving integrated circuit of an LCD device 240 includes a first polarity control transmission line 242, a second polarity control transmission line 241, a plurality of odd-numbered data driving integrated circuits 250, e.g., 1^{st} D-IC and 3^{rd} D-IC, and a plurality of even-numbered data driving integrated circuits 260, e.g., 2^{nd} D-IC and 4^{th} D-IC. The LCD device 240 may have one of twisted nematic (TN), vertical alignment (VA), in-plane switching (IPS), and fringe field switching (FFS) modes.

In addition, an odd-numbered polarity control signal POL_ODD is applied to the odd-numbered data driving integrated circuits 250 through the first polarity control transmission line 242, and an even-numbered polarity control signal POL_EVEN applied to the even-numbered data driving integrated circuits 260 through the second polarity control transmission line 241. Further, the odd-numbered polarity control signal POL_ODD and the even-numbered polarity control signal POL_EVEN are different from one another. For example, pixels driven by the odd-numbered data driving integrated circuit 250 has a different polarity type from pixels driven by the even-numbered driving integrated circuit 260. The polarity control signal POL_ODD or POL_EVEN is individually applied to each of the plurality of data driving integrated circuits 250 and 260.

Moreover, the LCD device 240 includes a plurality of pixels in a matrix form defined by intersections between gate lines and data lines. The driving integrated circuit divides the conventionally utilized single polarity control signal into a positive polarity (+) and a polarity control signal with a negative polarity (−) to generate the odd-numbered polarity control signal POL_ODD and the even-numbered polarity control signal POL_EVEN. The odd-numbered polarity control signal POL_ODD and the even-numbered polarity control signal POL_EVEN are simultaneously applied to the odd-numbered data driving integrated circuits 250 and the even-numbered data driving integrated circuit 260, respectively.

First, the positive polarity control signal is applied to the odd-numbered data driving integrated circuits 250 and simultaneously the negative polarity control signal is applied to the even-numbered data driving integrated circuits 260. Next, according to the corresponding polarity control signals respectively applied to the odd-numbered data driving integrated circuits 250 and the even-numbered data driving integrated circuits 260, a polarity of an inputted data is changed, and then a corresponding data voltage is applied to each data line of the LCD device 240 using the one-dot inversion driving scheme.

In the next frame, the polarity control signals are alternately applied, e.g., the negative polarity control signal is applied to the plurality of odd-numbered data driving integrated circuits and the positive polarity signal is applied to the plurality of even-numbered data driving integrated circuits. Accordingly, data having a polarity opposite to that in the previous frame is outputted.

FIG. 7 is a schematic diagram illustrating each pixel voltage polarity upon using the method shown in FIG. 6 in accordance with an embodiment of the present invention. FIG. 7 illustrates data lines at edges of even-numbered driving integrated circuits and odd-numbered driving integrated circuits to which different polarity control signals are respectively applied when one-line character is displayed on a screen based upon the one-dot inversion driving scheme. As shown in FIG. 7, upon employing the driving method using the odd-numbered polarity control signal and the even-numbered polarity control signal having different polarities from each other. When the same character is repeatedly generated across a wider display region, a character crosstalk occurrence is reduced more when using two separate polarity control signals having different polarities from each other as compared to using polarity control signals having the same polarity.

In particular, when the proportion of the negative polarity (−) voltage is higher than that of the positive polarity (+) voltage in driving the left one-line wide characters of the odd-numbered data driving integrated circuit 250, the proportion of the positive polarity (+) voltage is higher than that of the negative polarity (−) voltage in driving the right one-line wide characters of the even-numbered data driving integrated circuit 260. Accordingly, the positive polarity (+) voltage level and the negative polarity (−) voltage level become uniform to be attenuated by each other.

For example, when a gamma voltage ranges from 1V to 15V and a common voltage is 8V, pixels on the first horizontal line driven by the odd-numbered data driving integrated circuit 250 have the following actual voltages: 1V, 15V, 1V, 9V, 7V, 9V, 1V, 15V, 1V, 9V, 7V, and 9V. As such, the actual average voltage of the pixels driven by the odd-numbered data driving integrated circuit 250 is 7V. In addition, pixels on the first horizontal line driven by the even-numbered data driving integrated circuits 260 have the following actual voltages: 15V, 1V, 15V, 7V, 9V, 7V, 15V, 1V, 15V, 7V, 9V, and 7V. As such, the actual average voltage of the pixels driven by the even-numbered data driving integrated circuit 260 is 9V. Thus, the actual average voltage of the pixels of the entire first horizontal line yields to 9V, which is the same as the common voltage.

Hence, a current flowing from the odd-numbered data driving integrated circuits 250 is smaller than an uniformly flowing current from other data driving ICs, while a current flowing from the even-numbered data driving integrated circuits 260 is greater than the uniformly flowing current from other data driving ICs. Thus, there is no current changes in other data driving ICs, thereby preventing a voltage variation when operating a LCD panel. The odd-numbered driving integrated circuits and the even-numbered driving integated circuits control the polarities of the video signals according to a certain inversion scheme.

Furthermore, the gamma voltage driven in the data driving integrated circuits uses more uniform positive voltage polarities (+) and negative voltage polarities (−). Accordingly, more current is not required at any one side. In addition, the pixel driving voltage and the common voltage Vcom are not changed, thereby preventing character crosstalk on the screen.

Thus, when a one-line wide character is to be repeatedly generated on a screen display using the one-dot inversion scheme, the polarity driving method of the data driving integrated circuits is changed to thus enable a reduction of the occurrence of the undesirable character crosstalk phenomenon.

As described above, using the driving integrated circuit of the LCD panel employing the one-dot inversion scheme and the driving method thereof according to an embodiment of the present invention, control signals having different polarities from each other are applied to the alternate data driving integrated circuits. As a result, uniform gamma voltage and common voltage are applied to the LCD panel, to thereby prevent crosstalk.

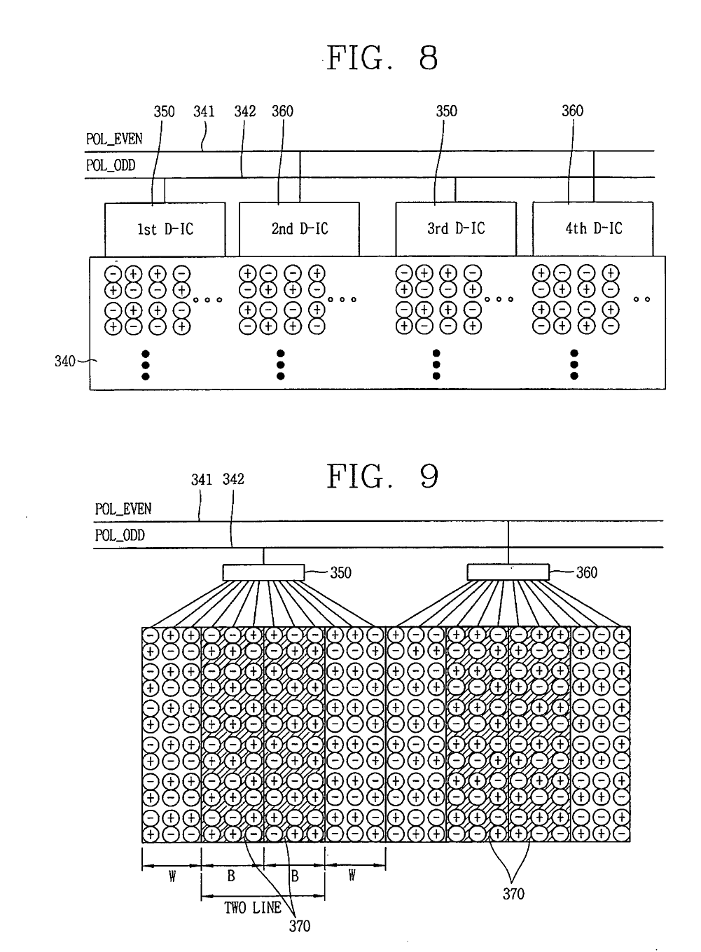

FIG. 8 is a schematic diagram illustrating a driving scheme by applying a horizontal two-dot inversion driving scheme in accordance with another embodiment of the present invention. In FIG. 8, a driving integrated circuit of an LCD device 340 includes a first polarity control transmission line 342, a second polarity control transmission line 341, a plurality of odd-numbered data driving integrated circuits 350, e.g., 1^{st} D-IC and 3^{rd} D-IC, and a plurality of even-numbered data driving integrated circuits 360, e.g., 2^{nd} D-IC and 4^{th} D-IC. The LCD device 340 may have one of twisted nematic (TN), vertical alignment (VA), in-plane switching (IPS), and fringe field switching (FFS) modes.

In addition, an odd-numbered polarity control signal POL_ODD is applied to the odd-numbered data driving integrated circuits 350 through the first polarity control transmission line 342, and an even-numbered polarity control signal POL_EVEN applied to the even-numbered data driving integrated circuits 360 through the second polarity control transmission line 341. Further, the odd-numbered polarity control signal POL_ODD and the even-numbered polarity control signal POL_EVEN are different from one another. For example, pixels driven by the odd-numbered data driving integrated circuit 350 has a different polarity type from pixels driven by the even-numbered driving integrated circuit 360. The polarity control signal POL_ODD or POL_EVEN is individually applied to each of the plurality of data driving integrated circuits 350 and 360.

Moreover, the LCD device 340 includes a plurality of pixels in a matrix form defined by intersections between gate lines and data lines. The driving integrated circuit divides the conventionally utilized single polarity control signal into a positive polarity (+) and a polarity control signal with a negative polarity (−) to generate the odd-numbered polarity control signal POL_ODD and the even-numbered polarity control signal POL_EVEN. The odd-numbered polarity control signal POL_ODD and the even-numbered polarity control signal POL_EVEN are simultaneously applied to the odd-numbered data driving integrated circuits 350 and the even-numbered data driving integrated circuit 360, respectively.

First, a positive polarity control signals is applied to the odd-numbered data driving integrated circuits 350 and simultaneously a negative polarity control signal is applied to the even-numbered data driving integrated circuits 360. Next, according to the corresponding polarity control signals respectively applied to the odd-numbered data driving integrated circuits 350 and the even-numbered data driving integrated circuits 360, a polarity of an inputted data is changed, and then a corresponding data voltage is applied to each data line of the LCD device 340 using the two-dot inversion driving scheme.

In the next frame, the polarity control signals are alternately applied, namely, the negative polarity control signal is applied to the plurality of odd-numbered data driving integrated circuits and the positive polarity signal is applied to the plurality of even-numbered data driving integrated circuits. Accordingly, data having an opposite polarity to that in the previously outputted frame is outputted.

FIG. 9 is a schematic diagram illustrating each pixel voltage polarity upon using the method shown in FIG. 8 in accordance with an embodiment of the present invention. FIG. 9 illustrates data lines at edges of even-numbered driving integrated circuits and odd-numbered driving integrated circuits to which different polarity control signals are respectively applied according to a two-line character is displayed on a screen based upon the two-dot inversion driving scheme.

As shown in FIG. 9, when the same character is repeatedly generated across a wide display region, a character crosstalk occurrence is reduced more when using two separate polarity control signals having different polarities from each other as compared to using polarity control signals having the same polarity. In particular, when the proportion of the negative polarity (−) voltage is higher than that of the positive polarity (+) voltage in driving display of the two-line wide characters of the odd-numbered data driving integrated circuit 350, the proportion of the positive polarity (+) voltage is higher than that of the negative polarity (−) voltage in driving display of the two-line wide characters of the even-numbered data driving integrated circuit 360. Accordingly, the positive polarity (+) voltage level and the negative polarity (−) voltage level become uniform to be attenuated by each other.

For example, when a gamma voltage ranges from 1V to 15V and a common voltage is 8V, pixels on the first horizontal line driven by the odd-numbered data driving integrated circuit 350 have the following actual voltages: 1V, 15V, 15V, 7V, 7V, 9V, 9V, 7V, 7V, 15V, 15V, and 1V. As such, the actual average voltage of the pixels driven by the odd-numbered data driving integrated circuit 350 is 9V. In addition, pixels on the first horizontal line driven by the even-numbered data driving integrated circuits 360 have the following actual voltages: 15V, 1V, 1V, 9V, 9V, 7V, 7V, 9V, 9V, 1V, 1V, and 15V. As such, the actual average voltage of the pixels driven by the even-numbered data driving integrated circuit 360 is 7V. Thus, the actual average voltage of the pixels of the entire first horizontal line yields to 9V, which is the same as the common voltage. The odd-numbered driving integrated circuits and the even-numbered driving integated circuits control the polarities of the video signals according to a certain inversion scheme.

Hence, a current flowing from the odd-numbered data driving integrated circuits 350 is greater than an uniformly flowing current from other data driving ICs, while a current flowing from the even-numbered data driving integrated circuits 360 is smaller than the uniformly flowing current from other data driving ICs. Thus, there is no current changes in other data driving ICs, thereby preventing a voltage variation when operating a LCD panel.

Furthermore, the gamma voltage driven in the data driving integrated circuits uses more uniform positive voltage polarities (+) and negative voltage polarities (−). Accordingly, more current is not required at any one side. In addition, the pixel driving voltage and the common voltage Vcom are not changed, thereby preventing character crosstalk on the screen.

Thus, when a two-line wide character is to be repeatedly generated on a screen display using the horizontal two-dot inversion scheme, the polarity driving method of the data line driving integrated circuits is changed to thus enable a reduction of the occurrence of the undesirable character crosstalk phenomenon. In addition, the embodiments of the present invention has been explained the one-dot inversion sheme and the two-dot inversion scheme. However, the present invention may not be limited thereto, but be applied to any inversion scheme which has both positive polarity and negative polarity in one horizontal line. As described above, using the driving integrated circuit of the LCD panel employing the two-dot inversion scheme and the driving method thereof according to an embodiment of the present invention, control signals having different polarities from each other are applied to the alternate data line driving integrated circuits. In addition, uniform gamma voltage and common voltage are applied to the LCD panel, to thereby prevent crosstalk. Such an LCD panel may have one of twisted nematic (TN), vertical alignment (VA), in-plane switching (IPS), and fringe field switching (FFS) modes.

Further, although not shown, the driving circuit and the driving method thereof according to an embodiment of the present invention that apply control signals having different polarities from each other are applied to the alternate data line driving integrated circuits may be employed in other display devices, such as plasma display panel (PDP) devices and electroluminescent display (ELD) devices.

It will be apparent to those skilled in the art that various modifications and variations can be made in the driving integrated circuit of a liquid crystal display device and the driving method thereof of the present invention without departing from the spirit or scope of the invention. Thus, it is intended that the present invention covers the modifications and variations of this invention provided they come within the scope of the appended claims and their equivalents.

What is claimed is:

1. A driving circuit for driving a liquid crystal display device, comprising:
at least one first driving integrated circuit receiving a first polarity control signal; and
at least one second driving integrated circuit receiving a second polarity control signal, the first polarity control signal being different from the second polarity control signal, the first and second driving integrated circuits respectively modifying a polarity of a set of video signals in accordance with the first and second polarity control signals.

2. The driving circuit according to claim 1, wherein the first and second polarity control signals have different polarities from each other.

3. The driving circuit according to claim 1, wherein the at least one first driving integrated circuit drives a first pixel portion, and the at least one second driving integrated circuit drives a second pixel portion to have a different polarity from the first pixel portion.

4. The driving circuit according to claim 1, wherein the at least one first driving integrated circuit and the at least one second driving integrated circuit locate alternately to one another.

5. The driving circuit according to claim 1, wherein the first and second driving integrated circuits control the polarities of the video signals according to a certain inversion scheme.

6. The driving circuit according to claim 1, wherein the first polarity control signal is applied to the first driving integrated circuit substantially simultaneously as the second polarity control signal is applied to the second driving integrated circuit.

7. A method of driving a liquid crystal display device, comprising:
generating a first polarity control signal;
generating a second polarity control signal, the first polarity control signal being different from the second polarity control signal;
applying the first polarity control signal to at least one first driving integrated circuit;
applying the second polarity control signal to at least one second driving integrated circuit;
controlling a polarity of a first set of video signals in accordance with the first polarity control signal; and
controlling a polarity of a second set of video signals in accordance with the second polarity control signal.

8. The method according to claim 7, wherein the first and second polarity control signals have different polarities from each other.

9. The method according to claim 7, further comprising:
driving a first pixel portion and a second pixel portion respectively by the first driving integrated circuit and the second driving integrated circuit to have different polarities from each other.

10. The method according to claim 9, wherein the first driving integrated circuit and the second driving integrated circuit locate alternately to one another.

11. The method according to claim 9, further comprising controlling the polarities of the video signals according to a certain inversion scheme.

12. The method according to claim 9, wherein the first polarity control signal is applied to the first driving integrated circuit at about the same time as the second polarity control signal is applied to the second driving integrated circuit.

13. The method according to 9, wherein the generating the first and second polarity control signals include dividing a polarity control signal into a positive polarity and a negative polarity.
